(19) United States
(12) Patent Application Publication
(10) Pub. No.: US 2024/0402810 A1
(43) Pub. Date: Dec. 5, 2024

(54) INFORMATION PROCESSING SYSTEM AND PEN-TYPE INPUT DEVICE

(71) Applicant: Lenovo (Singapore) Pte. Ltd., Singapore (SG)

(72) Inventors: Keiichi Yoshitomi, Kanagawa (JP); Mitsuhiro Yamazaki, Kanagawa (JP)

(73) Assignee: Lenovo (Singapore) Pte. Ltd., Singapore (SG)

(21) Appl. No.: 18/644,495

(22) Filed: Apr. 24, 2024

(30) Foreign Application Priority Data
Jun. 1, 2023 (JP) 2023-090919

(51) Int. Cl. G06F 3/01; G06F 3/0354; G06F 3/16

(52) U.S. Cl. CPC G06F 3/016; G06F 3/03545; G06F 3/16

(57) ABSTRACT

An information processing system includes: an information processing device and a pen-type input device. The information processing device includes: a sensor unit which is configured to detect contact of the pen-type input device and a parameter output unit which is configured to transmit feedback parameters which contain at least a parameter for controlling the vibration of the pen-type input device to the pen-type input device in accordance with detection of the contact by the sensor unit. The pen-type input device includes a vibration unit and a vibration control unit which is configured to vibrate the vibration unit on the basis of the feedback parameters which are received. At least either the pen-type input device or the information processing device includes a sound output control unit which is configured to output sounds from the sound output unit at a timing which accords with the vibration of the vibration unit.

### CROSS-REFERENCE TO RELATED APPLICATIONS

This application claims priority to Japanese Patent Application No. 2023-090919 filed on Jun. 1, 2023, the contents of which are hereby incorporated herein by reference in their entirety.

### TECHNICAL FIELD

The present invention relates to an information processing system, a pen-type input device and a non-transitory computer readable medium.

### BACKGROUND

In inputting into an interactive-type display system, it is known to use a pen-shaped stylus (a pen-type input device) which makes touch sense feedback possible by generating vibrations by driving a touch sense actuator as an input device.

Japanese Unexamined Patent Application Publication (Translation of PCT Application) No. 2017-537395

Since vibrations are generated from the pen-type input device and thereby it becomes possible to simulatively obtain a touch sense which is obtained when sliding the nib on a writing medium such as paper, it becomes possible for a user who performs an inputting operation by using the pen-type input device to obtain the touch sense which is close to a touch sense which is obtained when performing a writing operation on the writing medium.

In performing an inputting operation by using the pen-type input device, there exists such an aspect that it is preferable to approach the touch sense which is obtained when performing the writing operation on an actual writing medium as much as possible.

### SUMMARY

One or more embodiments of the present invention aim to come closer to the touch sense which is obtained when actually performing the writing operation on the writing medium on the occasion of inputting using the pen-type input device.

An information processing system according to one or more embodiments of the present invention includes an information processing device and a pen-type input device, in which the information processing device includes a sensor unit which is configured to detect contact of the pen-type input device and a parameter output unit which is configured to transmit feedback parameters which contain at least a parameter for controlling the vibration of the pen-type input device to the pen-type input device in accordance with detection of the contact by the sensor unit, the pen-type input device includes a vibration unit and a vibration control unit which is configured to vibrate the vibration unit on the basis of the feedback parameters which are received and at least either the pen-type device or the information processing device includes a sound output control unit which is configured to output sounds from the sound output unit at a timing which accords with the vibration of the vibration unit on the basis of the feedback parameters that the parameter output unit outputs.

A pen-type input device according to one or more embodiments of the present invention includes a communication unit which is configured to communicate with the information processing device which transmits feedback parameters which contain a parameter for controlling at least the vibration of the pen-type input device to the pen-type input device, depending on detection of the contact of the pen-type input device, a vibration unit, a vibration control unit which is configured to vibrate the vibration unit on the basis of the feedback parameters which are received and a sound output control unit which is configured to output a sound from a sound output section at a timing which complies with the vibration of the vibration unit on the basis of the feedback parameters which are received.

A non-transitory computer readable medium (CRM) storing computer readable program code according to one or more embodiments of the present invention is configured to make a computer, which serves as a pen-type input device, function as a communication unit which is configured to communicate with a sensor unit which detects contact of the pen-type input device and with an information processing device which transmits feedback parameters which include at least a parameter for controlling vibrations of the pen-type input device to the pen-type input device in accordance with detection of the contact by the sensor unit, as a vibration control unit which is configured to vibrate the vibration unit on the basis of the feedback parameters which are received and as a sound output control unit which is configured to output the sound from the sound output unit at a timing which complies with the vibration of the vibration unit on the basis of the feedback parameters which are received.

According to one or more embodiments of the present invention, when performing the inputting operation by using the pen-type input device, such an effect that it becomes possible to approach the touch sense which is obtained when actually performing the writing operation on the writing medium is obtained.

### BRIEF DESCRIPTION OF THE DRAWINGS

FIG. 1 is a diagram illustrating one example of an external configuration of an information processing system in one or more embodiments.

FIG. 2 is a diagram illustrating one example of a functional configuration which complies with touch sense-writing sound feedback of an information processing device and a pen-type input device in one or more embodiments.

FIG. 3 is a diagram illustrating one example of parameter data that a parameter storage unit in one or more embodiments stores.

FIG. 4 is a diagram illustrating one example of handwriting sound data that a handwriting sound data storage unit in one or more embodiments stores.

FIG. 5 is a flowchart illustrating one example of processing procedures that the information processing device and the pen-type input device in one or more embodiments execute in response to the touch sense-writing sound feedback.

FIG. 6 is a diagram illustrating one example of a functional configuration which complies with the touch sense-writing sound feedback of the information processing device and the pen-type input device in one or more embodiments.

FIG. 7 is a flowchart illustrating one example of processing procedures that the information processing device and the pen-type input device in one or more embodiments execute in response to the touch sense-writing sound feedback.

FIG. 8 is a diagram illustrating one example of a functional configuration which complies with the touch sense-writing sound feedback of the information processing device and the pen-type input device in one or more embodiments.

FIG. 9 is a flowchart illustrating one example of processing procedures that the information processing device and the pen-type input device in one or more embodiments execute correspondingly to the touch sense-writing sound feedback.

### DETAILED DESCRIPTION OF THE INVENTION

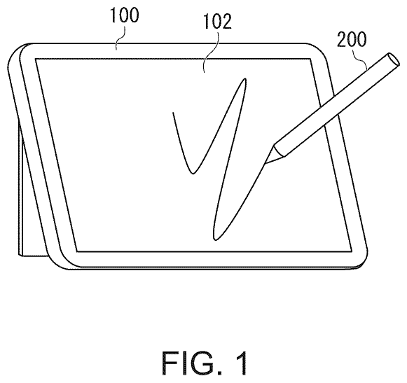

FIG. 1 illustrates one example of an external configuration of an information processing system according to one or more embodiments. As illustrated in FIG. 1, the information processing system according to one or more embodiments has an information processing device 100 and a pen-type input device 200.

The information processing device 100 is configured to make it possible to execute information processing in response to an inputting operation which is performed by the pen-type input device 200. FIG. 1 illustrates one example that the information processing device 100 is configured as a tablet terminal, a laptop PC or the like.

The information processing device 100 includes a touch panel display unit 102. The touch panel display unit 102 is a unit that a touch panel is combined with a display unit. The touch panel display unit 102 displays an image on a display surface and makes it possible to perform an operation of bringing operating bodies such as the pen-type input device, a finger and so forth into contact with the display surface.

The pen-type input device 200 is a pen-type input device that a user uses for performing an operation to a touch panel of the touch panel display unit 102 of the information processing device 100.

The user grips the pen-type input device 200, moves the nib so as to be brought into contact with the display surface of the touch panel display unit 102 and thereby performs a handwritten inputting operation of characters/letters, pictures, graphics and so forth.

Incidentally, with respect to “touch” of the nib on the display surface of the touch panel display unit 102 in a case of the operation which is performed by using the pen-type input device 200, although the nib does not physically touch the display surface other than a case where the nib is physically in contact with the display surface, also a state that the touch panel of the touch panel display unit 102 comes closer to a state that it becomes possible for the touch panel of the touch panel display unit 102 to detect the nib is included.

In addition, as an operation which is performed by using the pen-type input device 200, a pointing operation and so forth to a user interface image which is displayed on the touch panel display unit 102 may be made possible.

Incidentally, although there is no particular limitation to a detecting scheme of the pen-type input device 200 by the touch panel of the touch panel display unit 102 in one or more embodiments, for example, a capacitive method, a pressure sensitive method and so forth may be given.

An application (a pen operation adaptive application) which corresponds to an inputting operation which is performed by the pen-type input device 200 is installed in the information processing device 100.

The pen operation adaptive application may make it possible to execute various kinds of processing such as, processing of inputting letters/characters which is performed by bringing the nib of the pen-type input device 200 into contact with the touch panel display unit 102, processing of displaying letters/characters and pictures on the touch panel display unit 102 in accordance with a hand-written inputting operation such as picture drawing, and processing of digitalizing the letters/characters and the pictures which are drawn by the operations.

In addition, in the information processing system according to one or more embodiments, the pen type input device 200 vibrates, dealing with a situation that an operation (a writing operation) which accords with writing is being performed. Owing to vibrations of the pen-type input device 200 like this, it becomes possible for the user to sense a touch sense which is similar to a sense which is obtained when performing writing on the writing medium such as paper and thereby it becomes possible to obtain a sense which is similar to a sense which is obtained when performing a writing operation on the writing medium by using a real writing instrument.

Further, in the information processing system according to one or more embodiments, the pen-type input device 200 is configured to output a sound (a writing sound) which is generated by performing the writing operation on the writing medium by using the real writing instrument, dealing with a situation that the operation which accords with writing is being performed.

Also writing sounds are output together with generation of vibrations when the writing operation is being performed by using the pen-type input device 200 in this way and thereby it becomes possible to come closer to a sense which is obtained when writing on the writing medium by using the real writing instrument.

In the following description, vibration generation and output of the writing sounds when the writing operation is being performed by the pen-type input device 200 are also called “haptic sense-writing sound feedback”

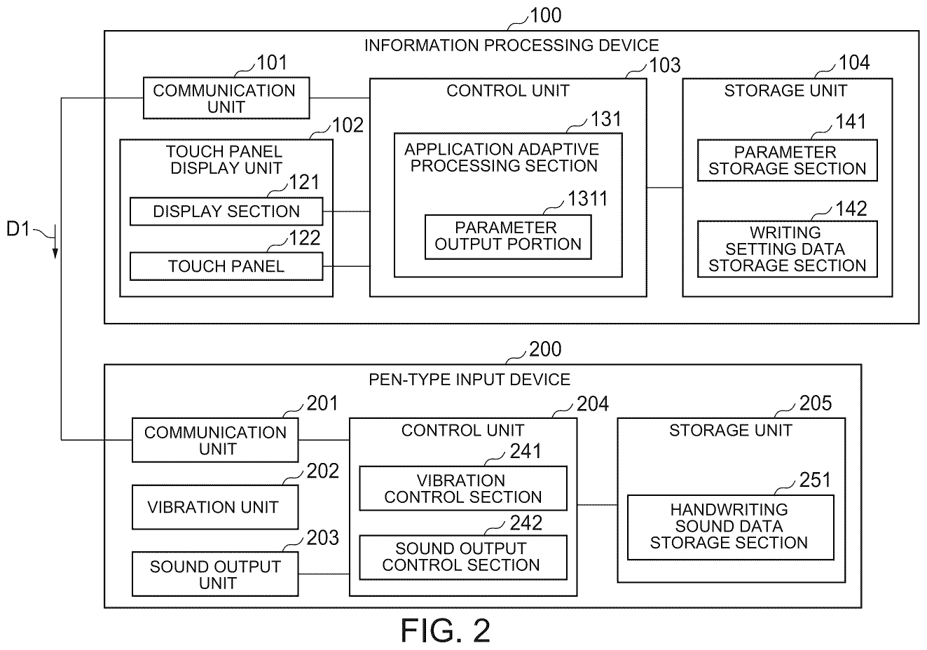

FIG. 2 illustrates an example of functional configurations of the information processing deice 100 and the pen-type input device 200 which accord with the touch sense-writing sound feedback in one or more embodiments.

First, the example of the functional configuration of the information processing device 100 will be described. The function as the information processing device 100 which is illustrated in FIG. 2 is realized by executing a program by a CPU (Central Processing Unit), a GPU (Graphics Processing Unit) and so forth that hardware which functions as the information processing device 100 includes.

In FIG. 2, the information processing device 100 includes a communication unit 101, the touch panel display unit 102, a control unit 103 and a storage unit 104.

The communication unit 101 performs wireless communication with the pen-type input device 200. There is no particular limitation on the system of the wireless communication that the communication unit 101 deals with. Incidentally, the communication unit 101 may be made to be applicable to wired communication with the pen-type input device 200.

The touch panel display unit 102 is a device which is configured by combining a display section 121 with a touch panel 122 (one example of a sensor section). The display section 121 displays images in accordance with control from the control unit 103. The touch panel 122 is installed in correspondence with the display surface of the display section 121, detects a position that the nib of the input device 200 touches and outputs coordinates of the detected position as pen operation information.

The control unit 103 executes various kinds of controlling operations in the information processing device 100. The control unit 103 includes an application-adaptive processing section 131 which executes processing which corresponds to the pen operation adaptive application.

The application-adaptive processing section 131 includes a parameter output portion 1311. In a case where a writing operation is being performed by using the pen-type input device 200 as an operation to be performed for the pen operation-adaptive application, pen operation information is input from the touch panel 122 into the application-adaptive processing section 131. The application-adaptive processing section 131 outputs feedback parameters for making the pen-type input device 200 perform an operation of touch sense-writing sound feedback. The communication unit 101 transmits a feedback parameter D1 which is output to the pen-type input device 200.

The storage unit 104 stores various kinds of information which corresponds to the information processing device 100. The storage unit 104 includes a parameter storage section 141 and a writing setting data storage section 142.

The parameter storage section 141 stores predetermined parameter data which is contained in the feedback parameters.

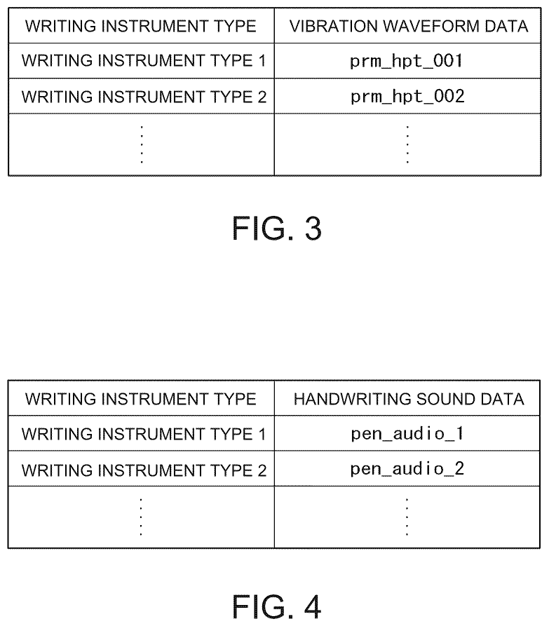

FIG. 3 illustrates one example of the parameter data that the parameter storage section 141 stores. In FIG. 3, an example that the parameter storage section 141 stores vibration waveform data and writing sound data as the parameter data in accordance with each writing instrument type is indicated.

The vibration waveform data is data which indicates a vibration waveform which is so formed as to generate a desired vibration state in the pen-type input device 200.

The pen operation-adaptive application in one or more embodiments is configured to make it possible to set the writing instrument type in execution of a writing operation by the pen-type input device 200. Specifically, as the types of writing instruments, it is possible to give types such as a pencil, a ballpoint pen, a crayon, a felt-tip pen, and a brush. The pen operation-adaptive application is so created as to perform drawing in handwriting which corresponds to the type of the writing instrument which is set in accordance with the writing operation which is performed by the pen-type input device 200.

Actually, the sense of touch which is sensed when writing on a writing medium differs depending on the type of the writing instrument which is used. Each piece of the vibration waveform data that the parameter storage section 141 stores is the one which is so prepared as to reproduce the sense of touch per corresponding type of the writing instrument.

Incidentally, the sense of touch which is sensed when writing also differs depending on the type of each writing medium such as, for example, foreign paper, Japanese paper, and resins. That is, the sense of touch which is sensed when performing writing differs for each combination of the type of the writing instrument and the type of the writing medium. Accordingly, the parameter storage section 141 may store, for example, parameter data (vibration waveform data) which differs for each combination of the type of the writing instrument and the type of the writing medium.

Description will be made by returning to FIG. 2.

The writing setting data storage section 142 stores setting data which contains data on the types of writing instruments (writing instrument type data) which is set in correspondence with the writing operation which is performed by the pen-type input device 200 in the pen operation adaptive application. Data (writing medium data) which indicates one writing medium which is set may be contained in writing setting data.

Next, an example of the functional configuration of the pen-type input device 200 will be described. The function of the pen-type input device 200 which is illustrated in FIG. 2 may be realized by, for example, making a microprocessor such as MCU (Micro Control Unit) that the pen-type input device 200 which works as hardware includes execute a program.

The pen-type input device 200 in FIG. 2 includes a communication unit 201, a vibration unit 202, a sound output unit 203, a control unit 204 and a storage unit 205.

The communication unit 201 is connected with the communication unit 101 of the information processing device 100 to be communicable.

The vibration unit 202 (an actuator) is a unit which vibrates in order to give a sense of touch which is obtained when performing the writing operation to the user who grips the pen-type input device 200. Vibrations that the vibration unit 202 generates are controlled by a vibration control section 241.

The sound output unit 203 includes, for example, a loudspeaker and outputs handwriting sounds in accordance with control by a sound output control section 242. Incidentally, the sound output unit 203 may be also configured to be able to output sounds such as, for example, electronic sounds, and voices.

The control unit 204 executes various kinds of controlling operations in the pen-type input device 200. The control unit 204 includes the vibration control section 241 and the sound output control section 242.

The vibration control section 241 makes the vibration unit 202 vibrate on the basis of vibration waveform data which is contained in a feedback parameter which is received.

The sound output control section 242 outputs audio data which serves as handwriting sound data that a handwriting sound data storage section 251 stores to the sound output unit 203 and thereby makes the handwriting sound output from the sound output unit 203.

The storage unit 205 stores various kinds of information that the pen-type input device 200 deals with. The storage unit 205 includes the handwriting sound data storage section 251.

The handwriting sound data storage section 251 stores the handwriting sound data. FIG. 4 illustrates one example of the handwriting sound data that the handwriting sound data storage section 251 stores. As illustrated in FIG. 4, the handwriting sound data storage section 251 stores the handwriting sound data in one-to-one correspondence with the types of writing instruments.

In reality, the handwriting sounds which are generated when performing writing on the writing medium mutually differ depending on the type of the writing instrument which is used. Each piece of the handwriting sound data that the handwriting sound data storage section 251 stores is the one which is so prepared as to reproduce handwriting sounds which are generated in one-to-one correspondence with the types of the writing instruments which correspond thereto.

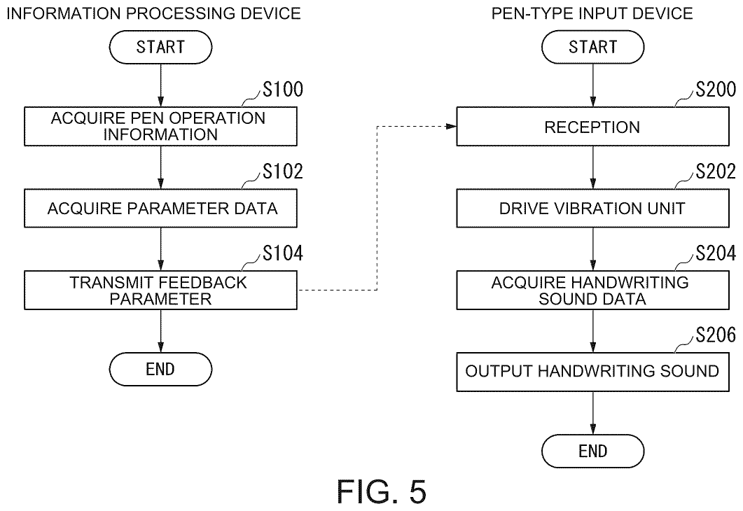

Examples of processing procedures that the information processing device 100 and the pen-type input device 200 which are configured as illustrated in FIG. 2 execute in correspondence with touch sense-writing sound feedback will be described with reference to the flowchart in FIG. 5.

First, an example of processing procedures that the information processing device 100 executes will be described.

Step S100: In the information processing device 100, the touch panel 122 detects coordinates which are specified in response to a handwriting operation which is performed by using the pen-type input device 200 and outputs pen operation information which indicates the coordinates which are detected. The application adaptive processing section 131 acquires the pen operation information which is output from the touch panel 122.

The application adaptive processing section 131 executes processing and so forth for drawing on the display unit 121 the brushstrokes which accord with the pen operation information which is acquired. On this occasion, for example, in a case where the parameter output portion 1311 receives writing pressure data which indicates the writing pressure that the pen-type input device 200 senses, the parameter output portion 1311 may draw so as to change the thickness and so forth of the brushstrokes in accordance with a writing pressure that the writing pressure data which is received indicates.

Step S102: In addition, the parameter output portion 1311 acquires parameter data which is to be contained in feedback parameters in response to acquisition of the pen operation information in the step S100.

For example, the parameter output portion 1311 decides the type of the writing instrument which is currently set with reference to the writing setting data that the writing setting data storage section 142 stores. The parameter output portion 1311 acquires data (the writing instrument type data) which indicates the type of the writing instrument which is decided as one piece of the parameter data. In addition, the parameter output portion 1311 acquires vibration waveform data which is stored in the parameter storage section 141 in correspondence with the type of the writing instrument which is decided as a feedback parameter. In addition, in a case where writing sound volume data that the sound volume of the writing sound which is output from the pen-type input device 200 is set is contained in the writing setting data, the parameter output portion 1311 may acquire the sound volume that the writing sound volume data indicates as one piece of the parameter data. Alternatively, in a case where the writing pressure data that the pen-type input device 200 transmits is received, the parameter output portion 1311 may acquire the writing sound volume which is set depending on the writing pressure that the writing pressure data which is received indicates as the parameter data.

Step S104: The parameter output portion 1311 makes the communication unit 101 transmit the feedback parameter D1 which contains the parameter data which is acquired in the step S102 to the pen-type input device 200.

Processing of acquiring the parameter data and transmitting the parameter data to the pen-type input device 200 as the feedback parameter D1 in the steps S102 and S104 may be also realized by API (Application Programming Interface) which is constructed in correspondence with the touch sense-writing sound feedback.

Next, an example of procedures of processing that the pen-type input device 200 executes will be described.

Step S200: In the pen-type input device 200, the communication unit 201 receives the feedback parameter D1 which is transmitted from the information processing device 100 in the step S104.

Step S202: The vibration control section 241 so drives the vibration unit 202 as to vibrate by utilizing vibration waveform data which is contained in the feedback parameter which is received in the step S200.

Step S204: In addition, the sound output control section 242 acquires the handwriting sound data which is stored in correspondence with each writing instrument type that the writing instrument type data which is contained in the feedback parameter which is received in the step S200 indicates from the handwriting sound data storage section 251.

Step S206: The sound output control section 242 makes writing sounds output from the sound output unit 203 on the basis of the handwriting sound data which is acquired in the step S204. On this occasion, in a case where writing sound volume data is contained in the feedback parameter, the sound output control section 242 may adjust the sound volume of the writing sound which is to be output from the sound output unit 203 on the basis of the writing sound volume data.

For example, although a picture drawing application which is configured to output sounds in accordance with writing by the pen-type input device is known, there also exists a picture drawing application which does not correspond to sound output which accords with writing. In this case, whether output of sounds which accords with writing is performed depends on whether the application has a function of corresponding to sound output which accords with writing.

On the contrary, according to the above-described configuration of one or more embodiments, even in a case where the picture drawing application does not have a sound outputting function which accords with writing, it becomes possible to output the writing sound by the pen-type input device 200 by making it possible to transmit a feedback parameter from the pen operation adaptive application to the pen-type input device 200 via the API. In addition, depending on the process in FIG. 4, vibration generation from the vibration unit 202 in the step S202 and output of the writing sounds in the step S204 are performed in correspondence with the same pen operation information which is acquired in the step S100 and are therefore performed at a synchronized timing. Specifically, the writing sound is output at a timing which is the same as the timing that the vibrations are generated from the pen-type input device 200.

In addition, in this case, it is sufficient for the information processing device 100 to apply the above-described API and thereby, for example, large-scale hardware and software change becomes unnecessary.

In addition, in one or more embodiments, the handwriting sound data on each writing instrument type is stored by using the pen-type input device 200 and then the writing instrument data which indicates the types of the writing instruments which are set by the pen-operation adaptive application is contained in the feedback parameter. Owing to such a configuration, it becomes possible to output the handwriting sound which fits the writing instrument type which is set by the pen-operation adaptive application. In addition, even in a case where a plurality of pen-operation adaptive applications of different types is implemented on the information processing device 100, since each of the pen-operation adaptive applications has the above-mentioned configuration, it becomes possible to output the handwriting sound which fits the writing instrument type which is set, in response to any pen-operation adaptive application.

In addition, in an application for use in picture drawing which is configured to output sounds in accordance with writing by a pen-type input device, sounds which accord with writing are output from an information processing device. On the other hand, in one or more embodiments, since the handwriting sounds are output from the pen-type input device 200, it becomes possible to get closer to a feeling which is obtained in a case where writing is performed actually by using the writing instrument.

Incidentally, in one or more embodiments, in place of the pen-type input device 200, the information processing device 100 may store the handwriting sound data in correspondence with each type of each writing instrument (or combination of each writing instrument type with each handwriting medium) as data which corresponds to the pen-operation adaptive application. In this case, in the feedback parameter, the handwriting sound data which is set in correspondence with the type of the writing instrument (or the combination of each writing instrument type with each handwriting medium) which is set is contained.

The pen-type input device 200 may output the writing sound by utilizing the handwriting sound data which is contained in the feedback parameter which is received.

Then, another embodiment will be described. The information processing system according to one or more embodiments is so configured as to output the writing sounds from the information processing device 100.

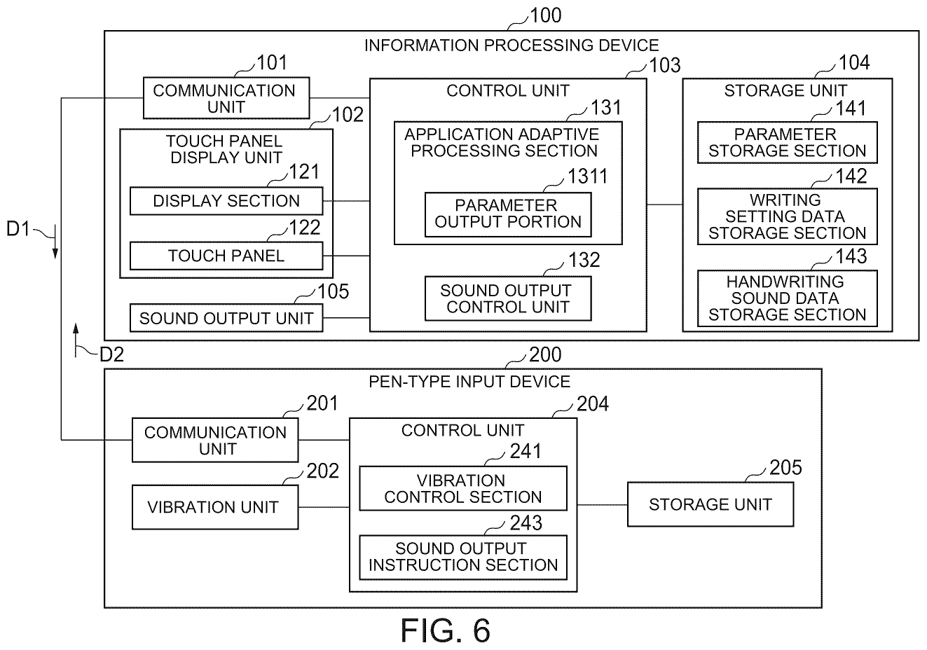

FIG. 6 illustrates one example of a functional configuration which accords with the touch sense-writing sound feedback of the information processing device 100 and the pen-type input device 200 in one or more embodiments. In FIG. 6, the same symbol is assigned to a part which is the same as the part in FIG. 2 and points which are different from the points in FIG. 2 will be mainly described.

In one or more embodiments, the control unit 103 of the information processing device 100 is equipped with a sound output control section 132.

In addition, the storage unit 104 of the information processing device 100 is equipped with a handwriting sound storage section 143 in addition to the parameter storage section 141 and the writing setting data storage section 142.

In addition, the information processing device 100 is equipped with a sound output unit 105.

The sound output control section 132 is a function section which is installed in correspondence with writing sound output software which is resident in the information processing device 100 and the handwriting sound data storage section 143 is a storage section which is installed in correspondence with the handwriting sound output software.

In the pen-type input device 200, the sound output unit 203, the handwriting sound data storage section 251 and the sound output control section 242 which are installed in FIG. 2 are omitted. In the control unit 204, a sound output instruction section 243 is installed in place of the sound output control section 242.

The sound output instruction section 243 instructs the sound output control section 132 of the information processing device 100 so as to output the handwriting sounds.

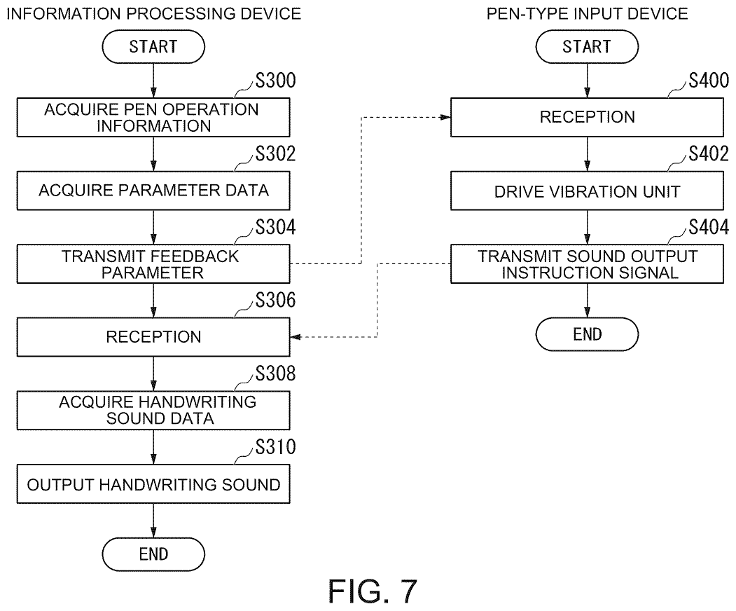

Examples of procedures of processing that the information processing device 100 and the pen-type input device 200 which are configured as illustrated in FIG. 6 execute in correspondence with the haptic sense-writing sound feedback will be described with reference to a flowchart in FIG. 7.

First, the example of the procedures of the processing that the information processing device 100 executes will be described.

The processes in steps S300 to S304 may be recognized to be the same as those in the steps S100 to S104 in FIG. 5.

Step S306: In response to transmission of the feedback parameter D1 in the step S304, a sound output instruction signal D2 is transmitted from the pen-type input device 200. The sound output instruction signal D2 is a signal for instructing output of the writing sounds to the sound output control section 132. In the information processing device 100, the communication unit 101 receives the sound output instruction signal D2 which is transmitted thereto. The sound output instruction signal contains the writing instrument type data, the writing sound volume data and so forth as the parameter data which is contained in the feedback parameter which is transmitted in the step S204.

Step S306: In response to reception of the sound output instruction signal D2, the writing sound data which is set in one-to-one correspondence with the types of the writing instruments that the writing instrument type data which is contained in the sound output instruction signal D2 which is received indicates is acquired from the writing setting data storage section 142 in accordance with reception of the sound output instruction signal D2.

Step S308: The sound output control section 132 makes the writing sounds output from the sound output unit 105 in accordance with the writing sound data which is acquired in the step S306. On this occasion, the sound volume of the writing sound which is to be output from the sound output unit 105 may be adjusted on the basis of the writing sound volume data which is contained in the sound output instruction signal D2 which is received.

Next, an example of procedures of the processing that the pen-type input device 200 executes will be described.

The processes in the steps S400 and S402 may be the same as the processes in the steps S200 and S202 in FIG. 5.

Step S404: The sound output instruction section 243 generates the sound output instruction signal D2 which contains the writing instrument type data (and the writing sound volume data) which are contained in the feedback parameter which is received in the step S400. The sound output instruction section 243 instructs to transmit the sound output instruction signal D2 which is generated to the information processing device 100 from the communication unit 201.

According to the configuration of the information processing system according to one or more embodiments which are described above, it becomes possible to output the writing sounds from the information processing device 100 together with the vibrations of the sense of touch which accords with the writing by the pen-type input device 200 in accordance with execution of the writing operation on the touch panel display unit 102 of the information processing device 100 with use of the pen-type input device 200, together with touch vibrations which are generated in accordance with writing by the pen-type input device 200. In addition, also by the processing in FIG. 7, generation of the vibrations from the vibration unit 202 in the S402 and output of the writing sounds in the step S404 are performed in correspondence with the same pen operation information which is acquired in the step S300 and therefore are performed at synchronized timings.

In addition, the pen-type input device 200 in one or more embodiments is configured to return the writing instrument type data (and the writing sound volume data) which are contained in the feedback parameters which are transmitted from the information processing device 100 as data which is utilizable for the sound output control section 132 of the information processing device 100 in a state of being contained in the sound output instruction signal D2. Owing to such a configuration as above, for example, even under the environment that a plurality of different types of pen-operation adaptive applications is introduced into the information processing device 100, it becomes possible to output the appropriate writing sounds which correspond to the writing instrument type which is set in correspondence with any one of the pen-operation adaptive applications.

Then, another embodiment will be described. The information processing system according to one or more embodiments is configured to output the writing sounds from the information processing device 100.

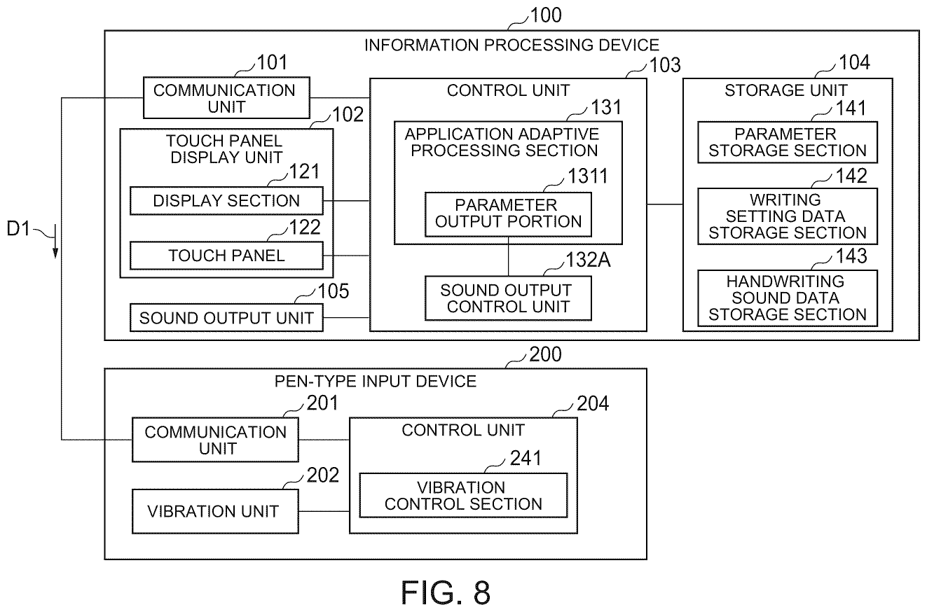

FIG. 8 illustrates one example of a functional configuration which accords with the haptic sense-writing sound feedback between the information processing device 100 and the pen-type input device 200 in one or more embodiments. In FIG. 8, the same symbols are assigned to the parts which are the same as those in FIG. 6 and points which are different from the points in FIG. 6 will be mainly explained.

In one or more embodiments, a sound output control section 132A is installed in the control unit 103 of the information processing device 100. In addition, in the pen-type input device 200, the sound output instruction section 243 is omitted.

The sound output control section 132A is a function section which is compatible with the writing sound output software which is resident in the information processing device 100 and is the same as the sound output control section 132 in FIG. 6 in this respect. However, although the sound output control section 132 in FIG. 6 is configured to output the writing sounds on the basis of the sound output instruction signal D2 which is transmitted from the pen-type input device 200, the sound output control section 132A in one or more embodiments is configured to acquire a feedback parameter that the parameter output portion 1311 outputs so as to be transmitted from the communication unit 101.

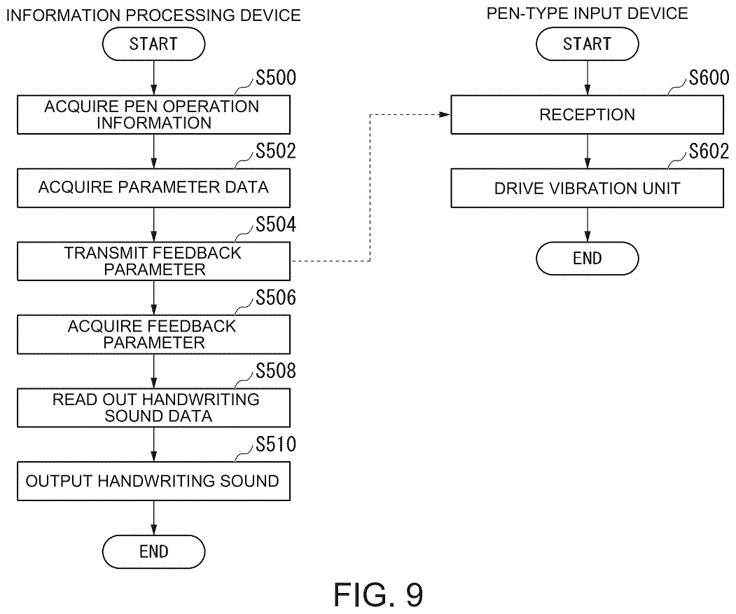

With reference to a flowchart in FIG. 9, an example of procedures of processing that the information processing device 100 and the pen-type input device 200 which are configured as illustrated in FIG. 8 execute in response to the haptic sense-writing sound feedback will be described.

First, the example of the procedures of the processing that the information processing device 100 executes will be described.

The processes in steps S500 to S504 may be regarded to be the same as the processes in the steps S300 to S304 in FIG. 7. However, with respect to the feedback parameter which is transmitted in the step S504, it is sufficient that only the vibration waveform data be contained and data which relates to output control of the writing sound such as the writing sound volume data and so forth may not be contained.

Step S506: The sound output control section 132A acquires the feedback parameter that the parameter output portion 1311 outputs to the communication unit 101 so as to be transmitted to the pen-type input device 200 in the step S504.

Step S508: The sound output control section 132A acquires the writing sound data which is set in one-to-one correspondence with the writing instrument types that the writing instrument type data which is contained in the feedback parameter which is acquired in step S506 indicates from the writing setting data storage section 142.

Step S510: The sound output control section 132A makes the writing sounds output from the sound output unit 105 on the basis of the writing sound data which is acquired in the step S508. On this occasion, in a case where the writing sound volume data is contained in the feedback parameter, the sound volume of the writing sounds which are output from the sound output unit 105 may be adjusted on the basis of the writing sound volume data.

The processes in the steps S600 and S602 that the pen-type input device 200 executes may be the same as the processes in the steps S400 and S402 in FIG. 7.

According to the configuration of the information processing system according to one or more embodiments which are described above, it becomes possible to output the writing sounds from the information processing device 100 in synchronization with the vibrations of the touch sense which are generated depending on writing by using the pen-type input device 200 in response to execution of the writing operation on the touch panel display unit 102 of the information processing device 100 with the use of the pen-type input device 200. In addition, the pen-type input device 200 is configured to vibrate the vibration unit 202 on the basis of the vibration waveform data which is contained in the feedback parameter D1 which is transmitted from the information processing device 100. Owing to the configuration such as the above, also in one or more embodiments, the pen-type input device 200 vibrates in response to a state that the user performs writing on the touch panel display unit 102 by using the pen-type input device 200 and it becomes possible to output the writing sounds which are synchronized with the vibrations of the pen-type input device 200 from the information processing device 100. In this case, in one or more embodiments, with regards to vibration waveforms, a vibration waveform which corresponds to the writing instrument type which is set may be contained in the feedback parameter D1 that the information processing device 100 transmits. Thereby, it becomes possible to transmit the vibrations which accord with the writing instrument type which is set to the pen-type input device 200. In addition, owing to the above-described configuration, also in one or more embodiments, even under such an environment that a plurality of different types of pen operation adaptive applications is installed in the information processing device 100, it becomes possible to output appropriate writing sounds which correspond to one writing instrument type which is set in correspondence with any pen-operation adaptive application.

Incidentally, the pen-type input device 200 and the information processing device 100 may be so configured as to make it possible to output the writing sounds from both of the pen-type input device 200 and the information processing device 100 by combining aspects of the configurations of the above-described embodiments. In this case, the pen-type input device 200 and the information processing device 100 may be configured to be switchable as to from which the writing sounds are output between the pen-type input device 200 and the information processing device 100 in accordance with, for example, the operation by the user, conditions of the application and so forth.

Incidentally, processing for functioning as the above-described information processing device 100, the pen-type input device 200 and so forth may be performed by recording a program for realizing the functions which serve as the above-described information processing device 100, the pen-type input device 200 and so forth into a computer-readable recording medium, reading the program which is recorded in the recording medium into a computer system and executing the program. Here, “reading the program which is recorded in the recording medium into the computer system and executing the program” includes to install the program into the computer system. Here, “the computer system” shall include OS and hardware such as peripherals and so forth. In addition, “the computer system” may include a plurality of computer devices which is connected together over a network which includes communication circuits such as the Internet, WAN, LAN, and dedicated lines. In addition, “the computer-readable recording medium” means portable media such as a flexible disc, a photomagnetic disc, ROM, and CD-ROM and storage devices such as HDD, SSD which are built in a computer system. As described above, the recording medium which stores a program may also be a non-transitory recording medium such as the CD-ROM. In addition, also a recording medium which is installed on the inner side or the outer side which is accessible from a distribution server for distributing the program concerned is also included in the recording medium. A code of a program which is to be stored into a recoding medium of a distribution server may be of the type which is different from a code of a program of the format which is executable by a terminal device. That is, as long as the program is of the type which is capable of being downloaded from the distribution server and installed in the form of being executable by the terminal device, the format which is to be stored in the distribution server doesn't matter. Incidentally, configurations which are obtained by dividing one program into a plurality of programs, downloading the programs at mutually different timings and thereafter unifying the programs by a terminal device and distribution servers which distribute the divided programs respectively may be different from one another. Further, “the computer readable recording medium” shall include the one which holds the program for a definite period of time just like a server in a case where the program is transmitted over a network and a nonvolatile memory (RAM) which is installed in a computer system which serves as a client. In addition, the above-described program may be of the type which is used for realizing some of the above-described functions. Further, the program may be of the type which can realize the above-described function by combination with a program which has already been recorded in the computer system, that is, may be a so-called differential file (a differential program).

### DESCRIPTION OF SYMBOLS

100 information processing device
101 communication unit
102 touch panel display unit
103 control unit
104 storage unit
105 sound output unit
121 display section
122 touch panel
131 application adaptive processing section
132 sound output control section
132A sound output control section
141 parameter storage section
142 writing setting data storage section
143 handwriting sound data storage section
200 pen-type input device
201 communication unit
202 vibration unit
203 sound output unit
204 control unit
205 storage unit
241 vibration control section
242 sound output control section
243 sound output instruction section
251 handwriting sound data storage section
1311 parameter output portion

What is claimed is:

1. An information processing system comprising:
an information processing device and
a pen-type input device, wherein
the information processing device includes
a sensor unit which is configured to detect contact of the pen-type input device and
a parameter output unit which is configured to transmit feedback parameters which contain at least a parameter for controlling vibration of the pen-type input device to the pen-type input device in accordance with detection of the contact by the sensor unit,
the pen-type input device includes
a vibration unit and
a vibration control unit which is configured to vibrate the vibration unit on the basis of the feedback parameters which are received and
at least either the pen-type input device or the information processing device includes a sound output control unit which is configured to output sounds from the sound output unit at a timing which accords with the vibration of the vibration unit on the basis of the feedback parameters that the parameter output unit outputs.

2. The information processing system according to claim 1, wherein
the sound output unit and the sound output control unit are installed in the pen-type input device in the pen-type input device and the information processing device.

3. The information processing system according to claim 1, wherein
the feedback parameters contain writing instrument type data which indicates writing instrument types which are set in correspondence with the pen-type input device and
the sound output unit outputs handwriting sounds which correspond to one writing instrument type that the writing instrument type data indicates.

4. The information processing system according to claim 1, wherein
the sound output unit and the sound output control unit are installed in the information processing device in the pen-type input device and the information processing device and,
the pen-type input device includes a sound output instruction unit which transmits a sound output instruction signal which contains a predetermined parameter which is contained in the feedback parameters and instructs the sound output control unit so as to output sounds in accordance with reception of the feedback parameters.

5. A pen-type input device comprising:
a communication unit which is configured to communicate with an information processing device which transmits feedback parameters which contain a parameter for controlling at least vibration of the pen-type input device to the pen-type input device, depending on detection of contact of the pen-type input device,
a vibration unit,
a vibration control unit which is configured to vibrate the vibration unit on the basis of the feedback parameters which are received and
a sound output control unit which is configured to output a sound from a sound output section at a timing which complies with the vibration of the vibration unit on the basis of the feedback parameters which are received.

6. A non-transitory computer readable medium (CRM) storing computer readable program code for making a computer, which serves as a pen-type input device, to function
as a communication unit which is configured to communicate with a sensor unit which detects contact of the pen-type input device and with an information processing device which transmits feedback parameters which include at least a parameter for controlling vibrations of the pen-type input device to the pen-type input device in accordance with detection of the contact by the sensor unit,
as a vibration control unit which is configured to vibrate the vibration unit on the basis of the feedback parameters which are received and
as a sound output control unit which is configured to output the sound from the sound output unit at a timing which complies with the vibration of the vibration unit on the basis of the feedback parameters which are received.
